(19) United States
(12) Patent Application Publication
(10) Pub. No.: US 2005/0050061 A1
(43) Pub. Date: Mar. 3, 2005

(54) System and method for dynamic meeting agenda with event firing progress indicators

(75) Inventor: Christopher K. Karstens, Apex, NC (US)

Correspondence Address: Gerald R. Woods;IBM Corporation T81/503, PO Box 12195, Research Triangle Park, NC, 27709, US

(73) Assignee: International Business Machines Corporation, Armonk, NY (US)

(21) Appl. No.: 10/648,991

(22) Filed: Aug. 27, 2003

(51) Int. Cl. G06F 7/00

(52) U.S. Cl. 707/100

(57) ABSTRACT

A system and method for dynamic meeting agenda with event firing progress indicators is presented. A meeting leader uses a computing device to dynamically manage an agenda that corresponds to a meeting. The leader selects agenda items as they are discussed and the computing device adjusts subsequent agenda item timeslots corresponding to the meeting's progression. The leader may also re-arrange the order of agenda items and the computing device automatically adjusts subsequent action items accordingly. Participants are notified of agenda item timeslot changes and subscribers are notified when they are allowed to join a meeting at a particular entry point.

### BACKGROUND OF THE INVENTION

1. Technical Field

The present invention relates in general to a system and method for dynamically managing an agenda and providing event firing progress indicators. More particularly, the present invention relates to a system and method for dynamically adjusting an agenda based upon a meeting's progression whereby participants are notified of agenda schedule changes and subscription acknowledgements.

2. Description of the Related Art

A business meeting typically follows a pre-defined agenda that includes multiple agenda items. Depending on an agenda's detail, the agenda may have an agenda schedule whereby each agenda item has a corresponding “timeslot”. The agenda is sent to participants that wish to attend the meeting locally or remotely. For example, a business may have a monthly staff meeting whereby a majority of the staff is located in North Carolina and a few other staff members are located in Europe. In this example, the staff members in North Carolina may reserve a conference room which has video conferencing capabilities or Internet conferencing capabilities which the European staff members may use to remotely participate in the staff meeting.

A challenge found is that business meetings seldom adhere to a pre-defined agenda schedule. Using the example described above, the business meeting's first agenda item may have a one-hour timeslot allotted for discussion but, due to its critical nature, actually took two hours to discuss. In another example, an agenda item presenter may ask a meeting leader to move his timeslot earlier in the agenda schedule in order to alleviate his scheduling conflicts, such as arriving at an airport on time for an airplane flight.

Another challenge found with business meetings that do not follow an agenda schedule is that a participant may waste time attending a meeting before or after he is required. Using the example described above, a participant that is presenting a third agenda item topic may arrive at the meeting at his designated timeslot, only to find out that the second agenda item topic presentation is just commencing because the second agenda item was delayed one hour due to the first agenda item exceeding its allotted time slot. In another example, an agenda item topic may proceed faster than its original schedule and finish 30 minutes early. In this example, a subsequent agenda item presenter may not arrive to the meeting until his originally scheduled timeslot which causes meeting participants to wait for 30 minutes until he arrives.

Furthermore, remote users may not wish to log on to a meeting until a particular agenda item is discussed. A challenge found, however, is that agenda items may have “do not disturb” indicators. A subscriber is not allowed to remotely join a meeting during the “do not disturb” time which forces the subscriber to monitor the meeting until the “do not disturb” indicator is removed.

What is needed, therefore, is a system and method for dynamically managing an agenda which notifies meeting participants of agenda changes and also allows users to pre-subscribe to a meeting at particular entry points.

### SUMMARY

It has been discovered that the aforementioned challenges are resolved by using a dynamic agenda which receives meeting leader inputs, adjusts agenda item timeslots, and notifies participants of schedule changes and meeting progression. A meeting leader uses a computing device (i.e. a laptop computer) to dynamically manage an agenda that corresponds to a particular meeting. The agenda may be stored on the leader's computing device or the agenda may be stored on a central calendar system which is accessible by the leader's computing device through a computer network, such as a LAN or the Internet.

In one embodiment, a meeting leader schedules a virtual meeting whereby each participant logs on to the meeting using remote meeting software and discusses agenda item topics through a computer network, such as the Internet. In another embodiment, the meeting leader schedules a meeting to partake in a meeting room and allows participants to remotely log on to the meeting.

The meeting leader selects a first agenda item on the agenda and a presenter starts his presentation. For example, the presenter may be a financial controller who presents financial information at a monthly staff meeting. The meeting leader's computing device processes the meeting leader's selection and adjusts a progress indicator included in the agenda which informs participants as to the progress of the meeting (e.g. the first agenda item is being discussed).

During the presenter's presentation, a subscriber wishes to remotely join the meeting. For example, the meeting may be in a room that is located in the United States and the subscriber may be located in Germany. The subscriber views the agenda on his computing device, and identifies an entry point that he may remotely join the meeting. An entry point is an instant in time that a meeting leader allows participants to join a meeting. For example, the meeting leader may set up entry points before each agenda item's timeslot. The subscriber sends a subscription request to the meeting leader's computing device through a computer network, such as the Internet. A subscription request includes a subscriber identifier and an entry point indicator corresponding to the time that the subscriber wishes to join the meeting. In an embodiment where the agenda is managed at a central calendar system, a subscriber's computing device sends a subscription request to the central calendar system.

The presenter finishes presenting the first agenda item 15 minutes earlier than what he is scheduled and the meeting leader selects the next agenda item on the agenda. The meeting leader's computing device identifies that the presenter finished early, and adjusts subsequent agenda item timeslots accordingly. The agenda item timeslot changes are updated on the agenda which participants may view in order to observe the meeting's progression.

The leader's computing device retrieves participant preference information, and identifies a participant that wishes to be notified of agenda schedule changes. The meeting leader's computing device sends an agenda notification to the participant's computing device which notifies the participant that the second agenda item, along with subsequent agenda items, commences fifteen minutes earlier than the agenda's original schedule. An agenda notification may be an instant message, an email, a page, or a synthesized telephone call informing the participant of the agenda change. In an embodiment where the agenda is located on a central calendar system, participant notifications are sent from the central calendar system.

When the meeting leader selects the next agenda item included in the agenda, the meeting leader's computing device detects a corresponding entry point and determines whether there are subscribers that wish to join the meeting at the particular entry point. The meeting leader's computing device identifies that a subscriber wishes to join the meeting at the particular entry point and the meeting leader's computing device subscribes the subscriber and sends a subscription notification to the subscriber's computing device through a computer network. The subscription notification informs the subscriber that he has joined the meeting.

In an embodiment where the agenda is located on a central calendar system, subscription requests and notifications are received by and sent from the central calendar system.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing a leader dynamically managing an agenda using a computing device whereby the computing device notifies participants of agenda changes and meeting progression;

FIG. 2A is a calendar window showing an agenda whose corresponding meeting starts on time;

FIG. 2B is a calendar window showing an agenda item finishing ten minutes early and a computing device adjusting times for subsequent agenda items;

FIG. 2C is a calendar window showing re-arranged agenda items and a meeting's progression;

FIG. 3 is a high-level flowchart showing steps taken in automatically revising an agenda;

FIG. 4 is a flow chart showing steps taken in starting a new agenda item;

FIG. 5 is a flowchart showing steps taken in updating an agenda to reflect agenda item progress and agenda item order changes;

FIG. 6 is a flowchart showing steps taken in subscribing to a meeting with do not disturb indicators; and

FIG. 7 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

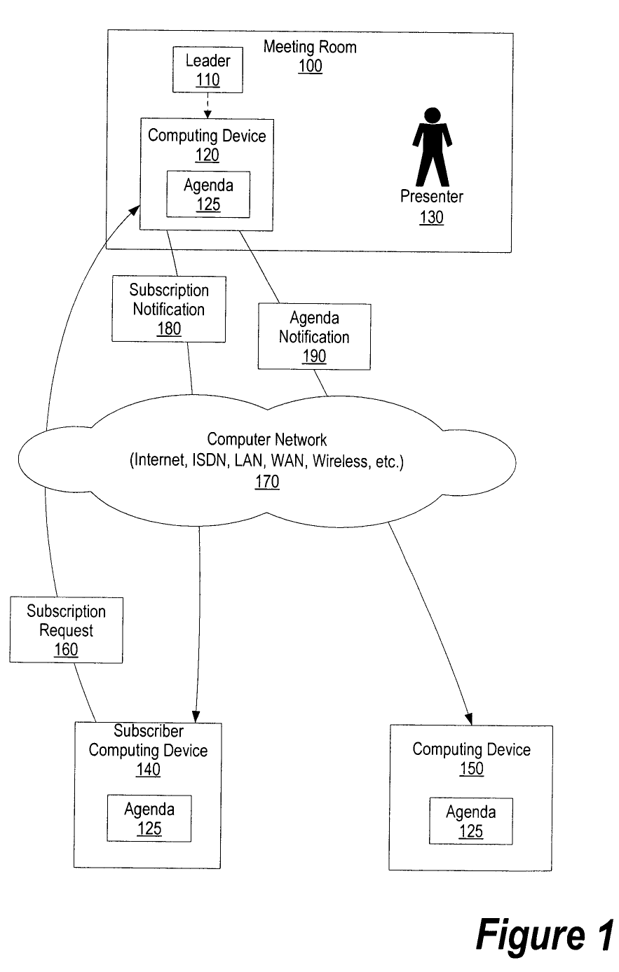

FIG. 1 is a diagram showing a leader dynamically managing an agenda using a computing device whereby the computing device notifies participants of agenda changes and meeting progression. Leader 110 is a leader of a meeting that is being held in meeting room 100. Leader 110 uses computing device 120 (i.e. a laptop computer) to dynamically manage agenda 125. Agenda 125 may be stored on computing device 120 or agenda 125 may be stored on a central calendar system which is accessible by computing device 120 through computer network 170, such as a LAN or the Internet. Agenda 125 includes a plurality of agenda items, each having agenda attributes. For example, agenda attributes for a particular agenda item may include a start time, a stop time, a timeslot, and a progress indicator, such as a font property (i.e. bolding the agenda item title).

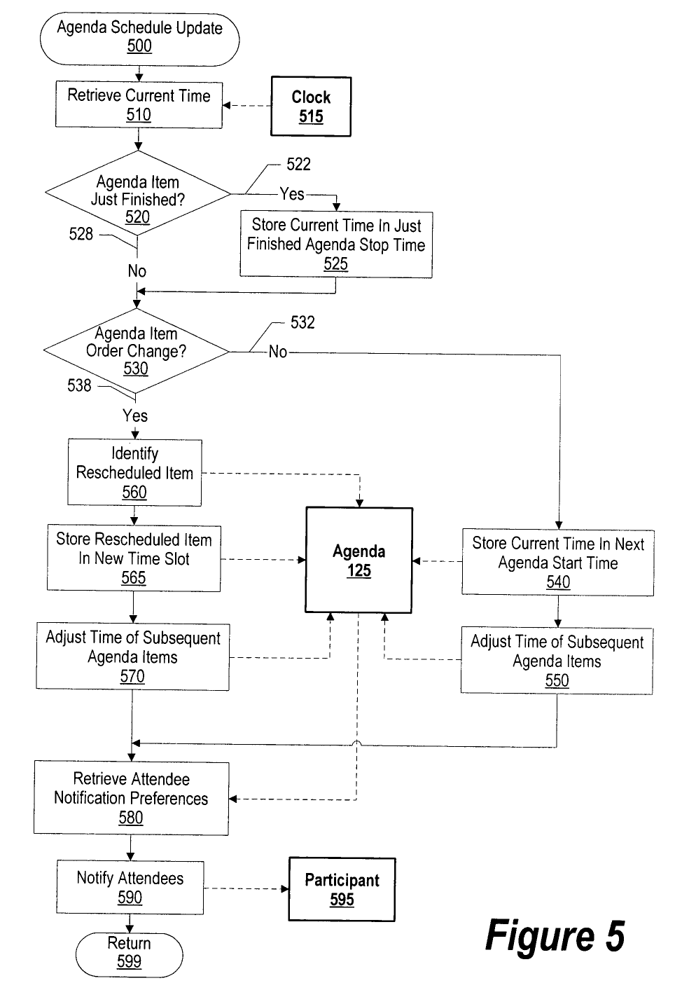

In one embodiment, an agenda item may have a “time window” agenda item attribute that corresponds to a particular timeframe that a presenter is available to present an agenda item. For example, an agenda item's time window may be from 11:00 AM until 2:00 PM which corresponds to a presenter's availability (see FIG. 5 and corresponding text for further details regarding time windows).

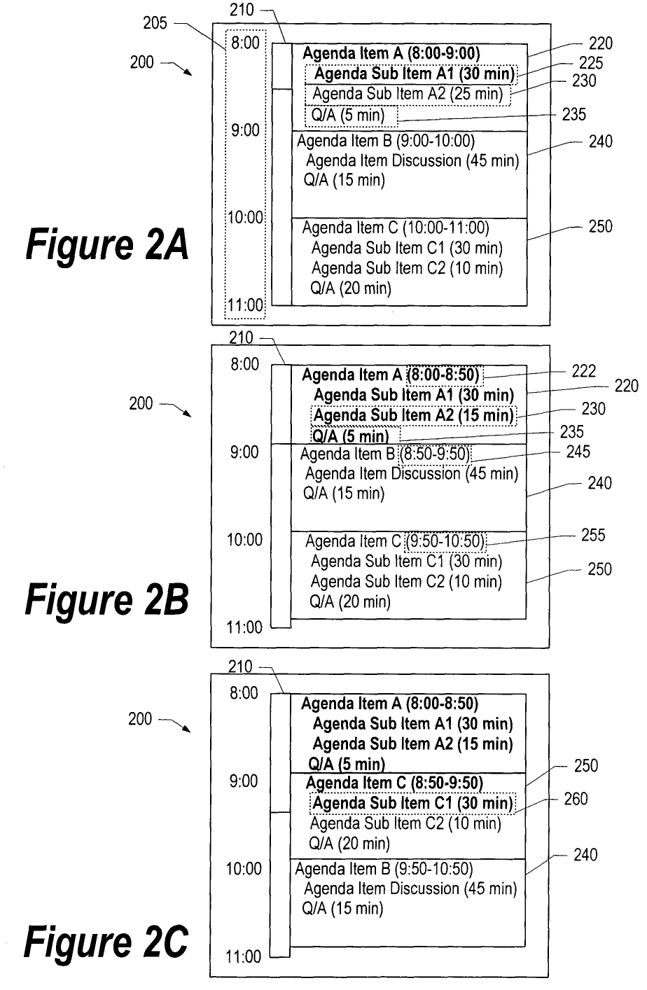

Presenter 130 enters meeting room 100 and is scheduled to discuss the first agenda item included in agenda 125. For example presenter 130 may be a financial controller who presents financial information at a monthly staff meeting. Leader 110 selects the first agenda item in agenda 125 and presenter 130 starts his presentation. Computing device 120 processes leader 110's selection and adjusts a progress indicator included in agenda 125 which informs participants as to the progress of the meeting (see FIGS. 2A, 2B, 2C, and corresponding text for further details regarding progress indicators).

During presenter 130's presentation, a subscriber that uses subscriber computing device 140 wishes to remotely join the meeting. For example, meeting room 100 may be located in the United States and the subscriber may be located in Germany. The subscriber views agenda 125 on subscriber computing device 140, and identifies an entry point that the subscriber may remotely join the meeting. An entry point is an instant in time that leader 110 allows participants to join a meeting. For example, leader 110 may set up entry points before each agenda item's timeslot. The subscriber sends subscription request 160 to computing device 120 through computer network 170, such as the Internet. Subscription request 160 includes a subscriber identifier and an entry point indicator corresponding to the timeslot that the subscriber wishes to join the meeting. In an embodiment where agenda 125 is managed at a central calendar system, subscriber computing device 140 sends subscription request 160 to the central calendar system. A remote meeting participant may join a meeting at any time when the current agenda item is not in a “do-not-disturb” state. In this situation, subscribing to an entry point may not be a requirement in order to join a meeting.

Presenter 130 finishes presenting fifteen minutes earlier than what he is scheduled. Leader 110 selects the next agenda item included in agenda 125. Computing device 120 identifies that presenter 130 finished early, and adjusts subsequent agenda item timeslots accordingly (see FIGS. 2 through 6, and corresponding text for further details regarding time slot adjustment). The agenda item timeslot changes are updated on agenda 125 in computing device 120, subscriber computing device 140, and participant computing device 150.

Computing device 120 retrieves participant preference information, and determines that a participant using computing device 150 wishes to be notified of agenda schedule changes. Computing device 120 sends agenda notification 190 to computing device 150 which notifies the participant that the second agenda item, along with subsequent agenda items, is starting fifteen minutes earlier than the agenda's original schedule. Agenda notification 190 may be an instant message, an email, a page, or a synthesized telephone call informing the participant of the agenda change.

When leader 110 selects the next agenda item included in agenda 125, computing device 120 detects an entry point and determines whether there are subscribers that wish to join the meeting at the particular entry point. Computing device 120 identifies that the subscriber using subscriber computing device 140 wishes to join the meeting at the particular entry point. Computing device 120 subscribes the subscriber and sends subscription notification 180 to subscriber computing device 140 through computer network 170. Subscription notification 180 informs the subscriber that the subscriber has joined the meeting.

In an embodiment where agenda 125 is located on a central calendar system, computing device 120 accesses agenda 125 through a computer network (i.e. LAN) and participant requests and notifications are received by and sent from the central calendar system.

FIG. 2A is a calendar window showing an agenda whose corresponding meeting starts on time. A meeting leader uses window 200 to track the progress of a meeting by selecting and re-arranging agenda items as required. Window 200 includes an agenda with agenda items 220, 240, and 250. Agenda item 220 is scheduled for discussion between 8:00 and 9:00. Agenda item 220 includes three sub-items 225, 230, and 235. Each sub-item is scheduled for a particular amount of time. For example, sub-item 225 is scheduled for 30 minutes. Agenda item 240 is scheduled for discussion between 9:00 and 10:00, and agenda item 250 is scheduled for discussion between 10:00 and 11:00.

Window 200 also includes progress bar 210. Progress bar 210 shows the progress of a meeting by showing which agenda items have been discussed and which agenda items are in process of being discussed. The example in FIG. 2A shows that sub-item 225 is being discussed. In one embodiment, window 200 may not include an actual progress bar but rather change the agenda item title's font (i.e. bold) which is also shown in FIG. 2A. Window 200 includes timeline 205 which corresponds to the agenda item timeslots.

As a meeting progresses, a meeting leader selects agenda items and sub-items whereby a computing device refreshes the progress bar (or changes font of agenda item titles) which informs remote participants that are viewing the agenda as to how the meeting is progressing.

FIG. 2B is a calendar window showing an agenda item finishing ten minutes early and a computing device adjusting times for subsequent agenda items. A meeting in progress finished its first agenda item ten minutes early. Window 200 shows that agenda item 220 finished at 8:50 when it was originally scheduled to finish at 9:00 (see FIG. 2A and corresponding text for further details regarding an original agenda item schedule). Text box 222 shows the actual time that agenda item 220 occurred is from 8:00-8:50. The reason that agenda item 220 finished early is because sub-item 230 took 15 minutes to discuss instead of its originally scheduled timeslot of 25 minutes. Progress bar 210 shows the progress of the meeting. Sub-items 230 and 235's title font change also indicates the meeting's progression.

Since agenda item 220 finished ten minutes early, window 200 shows subsequent agenda item timeslots adjusted accordingly. Agenda item 240 was originally scheduled for discussion between 9:00 and 10:00 and is now scheduled for discussion between 8:50 and 9:50. Likewise, agenda item 250 was originally scheduled for discussion between 10:00 and 11:00 and is now scheduled for discussion between 9:50 and 10:50. Text boxes 245 and 255 show these new timeslots, respectively. As agenda items start and finish, notifications are sent to remote participants informing them of the meeting's progress (see FIGS. 1, 4, 5 through 6, and corresponding text for further details notifications).

FIG. 2C is a calendar window showing re-arranged agenda items and a meeting's progression. A meeting finished its first agenda item ten minutes early whereby a presenter for a second agenda item was not available. Instead of waiting until the presenter arrived, the meeting leader decided to re-arrange agenda items by switching timeslots between the second agenda item and a third agenda item.

Window 200 shows that agenda item 250, which was originally scheduled to be the third agenda item, is now the second agenda item for discussion (see FIG. 2A, 2B and corresponding text for further details regarding original agenda item ordering). Progress bar 210 shows that sub-item 260 is currently under discussion. Sub-item 260's font is also bolded which informs a participant that it is currently being discussed. Agenda item 240, which was originally scheduled for discussion between 8:50 and 9:50, is now scheduled for discussion between 9:50 and 10:50.

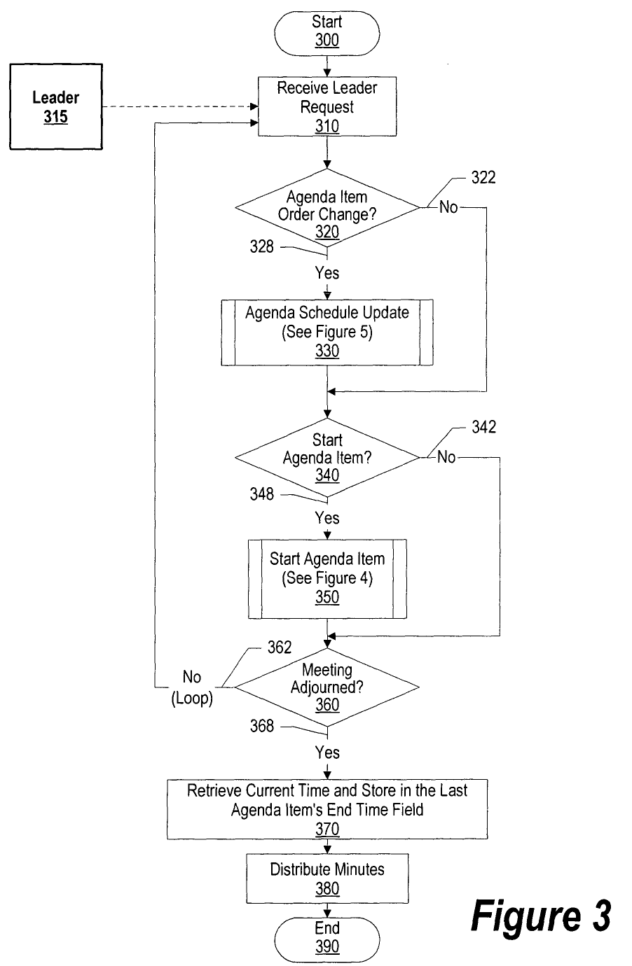

FIG. 3 is a high-level flowchart showing steps taken in automatically revising an agenda. The agenda includes a plurality of agenda items, each of which having a corresponding timeslot. The agenda item may also include sub-agenda items. For example, an agenda item “Financial” may have sub-items items including “Last Month Revenue”, “Expense Budget”, and “Forecast.” Each agenda item has one or more agenda item attributes, such as a start time, an end time, a progress indicator, and a font property (see FIGS. 2A, 2B, 2C, and corresponding text for further details regarding agenda items and sub-items). A meeting leader, such as leader 315, automatically revises the agenda using a computing device (i.e. laptop computer) that is connected to a central calendar system through a network, such as through an Ethernet connection or a wireless connection.

Processing commences at 300, whereupon processing receives a request from leader 315 (step 310). Leader 315 may provide the request using a pointing device, such as a mouse, or using a keyboard. A determination is made as to whether leader 315's request is an agenda item order change request (decision 320). For example, leader 315 may wish to re-arrange one of the agenda items to accommodate a presenter's schedule. If leader 315's request is an agenda item order change request, decision 320 branches to “Yes” branch 328 whereupon the request is processed (pre-defined process block 330, see FIG. 5 and corresponding text for further details). On the other hand, if leader 315's request is not an agenda item order change request, decision 320 branches to “No” branch 322 bypassing agenda schedule update processing steps. Leader 315 may add, delete, or modify an agenda item at any time during a meeting.

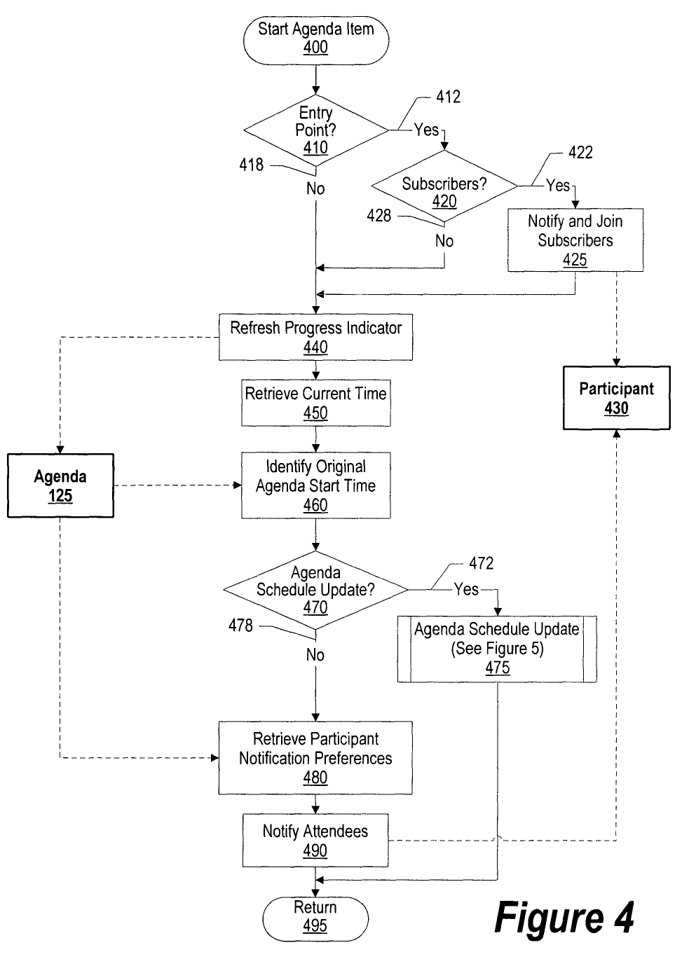

A determination is made as to whether leader 315's request is a start agenda item request (decision 340). For example, leader 315 may begin a meeting and wish to start discussing the first agenda item. If leader 315's request is a start agenda item request, decision 340 branches to “Yes” branch 348 whereupon the start agenda item request is processed (pre-defined process block 350, see FIG. 4 and corresponding text for further details). On the other hand, if leader 315's request is not a start agenda item request, decision 340 branches to “No” branch 342 bypassing start agenda item processing steps.

A determination is made as to whether leader 315's request is a meeting adjourned request (decision 360). For example, leader 315's meeting may finish discussing the last agenda item on the agenda, and leader 315 wishes to adjourn the meeting. If leader 315's request is not a meeting adjourn request, decision 360 branches to “No” branch 362 which loops back to continue processing requests. This looping continues until processing receives a meeting adjourned request, at which point decision 360 branches to “Yes” branch 368 whereupon processing retrieves a current time from a system clock, and stores the time in the last agenda item's stop time field (step 370). Processing then distributes meeting minutes to meeting participants at step 380. For example, leader 315 may enter meeting notes corresponding to each agenda item whereby processing distributes the meeting notes to each participant at the end of a meeting. Processing ends at 390.

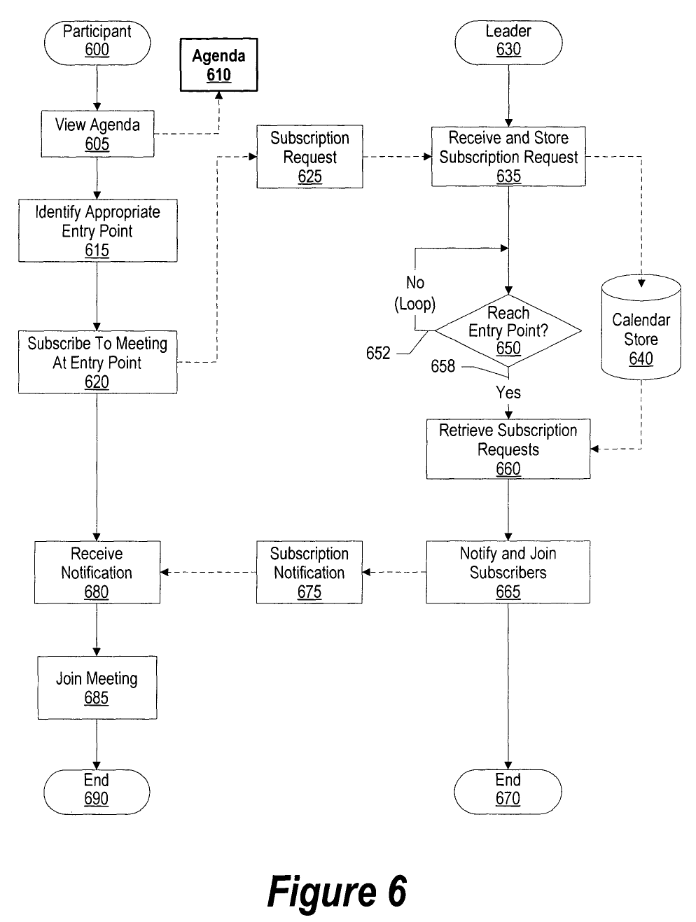

FIG. 4 is a flow chart showing steps taken in starting a new agenda item. For example, a presenter may be finished discussing a first agenda item and a meeting leader wishes to start discussing a second agenda item. Processing commences at 400, whereupon a determination is made as to whether an entry point exists corresponding to the new agenda item (decision 410). An entry point is an instant in time at which remote participants are allowed to join a meeting. For example, a leader may allow participants to remotely join a meeting between agenda item discussions but not during an agenda item discussion (see FIGS. 1, 6, and corresponding text for further details regarding entry points).

If processing does not detect an entry point corresponding to the new agenda item, decision 410 branches to “No” branch 418 bypassing entry point processing steps. On the other hand, if processing detects an entry point corresponding to the new agenda item, decision 410 branches to “Yes” branch 412 whereupon a determination is made as to whether one or more participants have requested to join the meeting at the entry point (decision 420). Processing may determine this by retrieving subscription requests that were previously sent from subscribers (see FIG. 1, 6, and corresponding text for further details regarding subscription requests). If there are no participants wishing to subscribe to the meeting at the particular entry point, decision 420 branches to “No” branch 428 bypassing subscription processing steps. On the other hand, if there are participants requesting to subscribe to the meeting at the entry point, decision 420 branches to “Yes” branch 422 whereupon processing subscribes the one or more participants to the meeting and notifies the participants, such as participant 430 (step 425).

Processing refreshes a progress indicator on agenda 125 at step 440 which is a visual representation of the meetings progress. The progress indicator may be a sidebar or the progress indicator may be a font change of an agenda item title (see FIGS. 2A, 2B, 2C and corresponding text for further details regarding progress indicators). Remote participants view agenda 125's progress indicator in order to see the progress of the corresponding meeting.

Processing electronically retrieves a current time at step 450, such as from a computing device's system clock. Processing identifies an original start time from agenda 125 that corresponds to the agenda item. For example, the agenda item may be scheduled to start at 12:00 PM. A determination is made as to whether the agenda requires updating by comparing the current time with the original start time (decision 470). Using the example described above, if the current time is 12:15 PM, the agenda requires updating because the agenda item is starting fifteen minutes later than the scheduled time. If the agenda requires updating, decision 470 branches to “Yes” branch 472 whereupon the agenda schedule is updated and participants are notified (pre-defined process block 475, see FIG. 5 and corresponding text for further details).

A notification threshold may be set at an overall agenda level or at a specific agenda item level. The notification threshold specifies a maximum amount of time an agenda may be ahead of schedule or behind schedule before agenda notifications are sent. For example, the ahead time may be set to 10 minutes and the behind time may be set to 20 minutes. In this example, if the meeting is running eight minutes ahead of schedule, the agenda is updated but notifications are not sent to participants. In this example, however, if the meeting is running 12 minutes ahead of schedule, the agenda is updated and notifications are sent to participants. The notification threshold suppresses trivial agenda schedule changes (i.e. three minutes ahead of schedule).

On the other hand, if the agenda item start time matches the current time, decision 470 branches to “No” branch 478 bypassing agenda schedule changing steps. Processing retrieves participant notification preferences from agenda 125 at step 480. Participant notification preferences inform processing as to which participants wish to be notified when a new agenda item starts. Processing notifies participants at step 490 (e.g. participant 430) that the agenda item is starting. Processing may notify a participant using an instant message, sending an agenda item reminder notice, sending a page, or sending a synthesized speech message to a participant's telephone. Processing returns at 495.

FIG. 5 is a flowchart showing steps taken in updating an agenda to reflect agenda item progress and agenda item order changes. Processing commences at 500, whereupon processing retrieves a current time from clock 515. For example, clock 515 may be a system clock located on a meeting leader's computing device. A determination is made as to whether an agenda item just finished (decision 520). For example, meeting participants may have just finished discussing a first agenda item and the meeting leader wishes to start a second agenda item. If an agenda item just finished, decision 520 branches to “Yes” branch 522 whereupon processing stores the current time in the agenda item's stop time field (step 525). Using the example described above, the current time may be 10:00 AM and processing stores “10:00 AM” in the first agenda item's stop time field. Processing stores this information in order for a meeting leader to track the length of each agenda item as well as inform other participants as to the progress of particular agenda items.

On the other hand, if an agenda item did not just finish, decision 520 branches to “No” branch 528 bypassing stop time entering steps. For example, a meeting leader may be starting a meeting's first agenda item.

A determination is made as to whether there is an agenda item order change (decision 530). For example, a meeting leader may move an agenda item that is originally scheduled from 4:00 PM-5:00 PM to the beginning of the agenda in order to allow the agenda item's presenter to be on time for an airplane flight. If there is not an agenda item order change, decision 530 branches to “No” branch 532 whereupon processing stores the current time in the new agenda item's start time field located in agenda 125 (step 540). For example, an agenda item order may not have changed but the meeting is progressing faster than what the original agenda specified. In this example, an agenda item's original start time may be 2:00 PM but the meeting leader is ready to start discussing the agenda item at 1:45 PM. Agenda 125 is the same agenda that is shown in FIGS. 1 and 4, and may be located on a central calendar system which is accessed through a computer network, such as a LAN. Processing adjusts the timeslots of subsequent agenda items located in agenda store 125 at step 550. Using the example described above, processing adjusts each subsequent agenda item's timeslot fifteen minutes earlier than their original timeslot. In one embodiment, processing captures a time difference between the original start time and an actual start time and adjust the subsequent agenda item's timeslots based upon the time difference.

On the other hand, if there is an agenda item order change, decision 530 branches to “Yes” branch 538 whereupon processing identifies the agenda item that is changing order in agenda 125. Processing stores the rescheduled agenda item in a new requested timeslot in agenda 125 at step 565. Using the example described above, the agenda item that was scheduled from 4:00 PM-5:00 PM is moved to 12:00 PM-1:00 PM. Processing then adjusts the timeslots of subsequent agenda items located in agenda 125 at step 570. Using the example described above, each agenda item starting at 12:00 PM is moved one hour later in order to accommodate the agenda item order change. In this example, the original agenda item that was scheduled from 12:00-1:00 pm is moved to 1:00 PM-2:00 PM.

In one embodiment, an agenda item may have a “time window” agenda item attribute that corresponds to a particular timeframe that a presenter is available to present an agenda item. Using the example described above, processing may analyze an agenda item's “time window” to ensure that the presenter is available to present during the adjusted timeslot. In this embodiment, processing attempts to contain each agenda items within its time windows. If processing is not able to contain a particular agenda item within its time window, a meeting leader is prompted that the particular agenda item will be removed because the agenda item falls outside of its time window. The meeting leader may choose to remove the particular agenda item from the agenda whereby generating a notification to meeting participants. The meeting leader may also choose to exchange a different agenda item with the particular agenda item so the particular agenda item may be presented within its time window.

Processing retrieves participant notification preferences from agenda 125 at step 580 which informs processing of participants requesting to be notified of a schedule change. Processing notifies the requesting participants of the schedule change, such as participant 595,at step 590, and processing returns at 599.

FIG. 6 is a flowchart showing steps taken in subscribing to a meeting with do not disturb indicators. For example, a meeting may allow remote participants to join a meeting at particular instances in time (i.e. entry points), such as between agenda item discussions. Processing commences at 600, whereupon a participant uses his computing device to view agenda 610 (step 605). Agenda 610 corresponds to a meeting that the attendee wishes to participate and may be stored on a central calendar system.

The participant identifies an entry point that he wishes to join the meeting at step 615. For example, the participant may wish to join the meeting before a third agenda item is discussed. In this example, the participant selects an entry point prior to the third agenda item discussion. The participant's computing device subscribes to the selected entry point at step 620 by sending subscription request 625 to a leader. Subscription request 625 includes the participant's identification as well as the participant's requested entry point location. In one embodiment, the participant sends a subscription request to a central calendar server which, in turn, notifies the leader. In another embodiment, a leader may choose to allow or not allow a particular participant to join a meeting. In this embodiment, the leader may configure a subscriber identification list whereby processing matches the list with the subscriber identifier included in subscription request 625.

Leader processing commences at 630, whereby the leader's computing device (or central calendar server) receives subscription request 625 and stores it in calendar store 640. Calendar store 640 may be stored on a nonvolatile storage area, such as a computer hard drive. A determination is made as to whether the meeting has reached an entry point (decision 650). For example, the meeting may have just finished discussing an agenda item and may be ready to start discussing a subsequent agenda item. If the meeting has not reached an entry point, decision 650 branches to “No” branch 652 which loops back to wait for an entry point. This looping continues until the meeting reaches an entry point, at which point, decision 650 branches to “Yes” branch 658.

Processing retrieves one or more subscription requests corresponding to the entry point from calendar store 640 at step 660. Processing then joins each subscriber and sends subscription notification 675 to the subscribers (step 665). Leader processing ends at 670.

Participant processing receives subscription notification 675 at step 680, and joins the meeting at step 685. A participant may join a meeting telephonically, through the Internet or use video conferencing capability. Participant processing ends at 690.

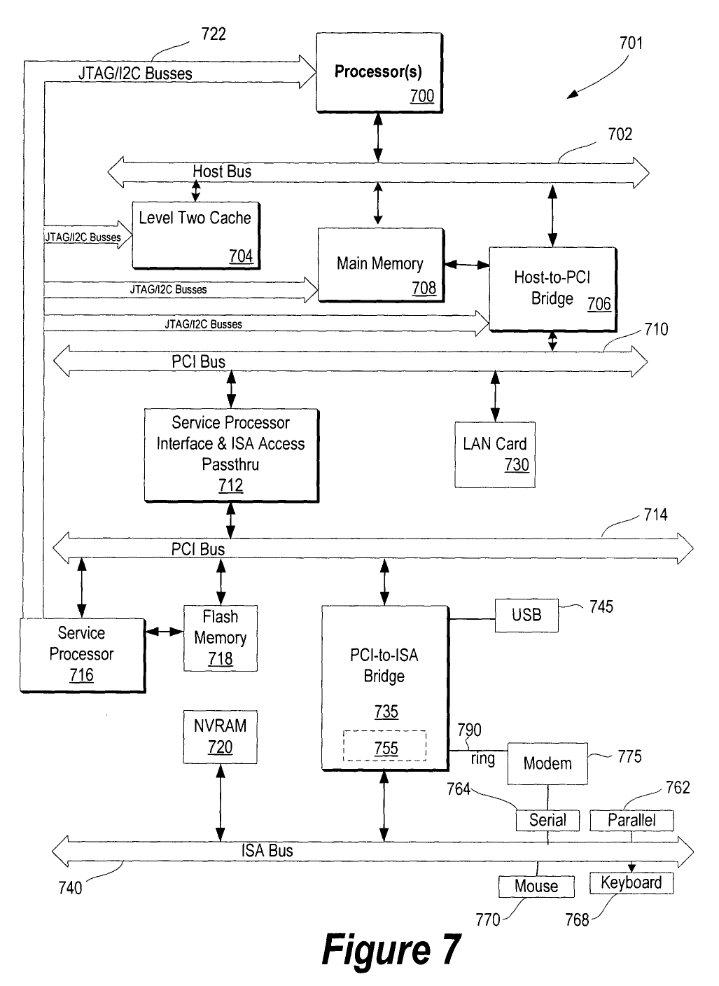

FIG. 7 illustrates information handling system 701 which is a simplified example of a computer system capable of performing the computing operations described herein. Computer system 701 includes processor 700 which is coupled to host bus 702. A level two (L2) cache memory 704 is also coupled to host bus 702. Host-to-PCI bridge 706 is coupled to main memory 708, includes cache memory and main memory control functions, and provides bus control to handle transfers among PCI bus 710, processor 700, L2 cache 704, main memory 708, and host bus 702. Main memory 708 is coupled to Host-to-PCI bridge 706 as well as host bus 702. Devices used solely by host processor(s) 700, such as LAN card 730, are coupled to PCI bus 710. Service Processor Interface and ISA Access Pass-through 712 provides an interface between PCI bus 710 and PCI bus 714. In this manner, PCI bus 714 is insulated from PCI bus 710. Devices, such as flash memory 718, are coupled to PCI bus 714. In one implementation, flash memory 718 includes BIOS code that incorporates the necessary processor executable code for a variety of low-level system functions and system boot functions.

PCI bus 714 provides an interface for a variety of devices that are shared by host processor(s) 700 and Service Processor 716 including, for example, flash memory 718. PCI-to-ISA bridge 735 provides bus control to handle transfers between PCI bus 714 and ISA bus 740, universal serial bus (USB) functionality 745, power management functionality 755, and can include other functional elements not shown, such as a real-time clock (RTC), DMA control, interrupt support, and system management bus support. Nonvolatile RAM 720 is attached to ISA Bus 740. Service Processor 716 includes JTAG and I2C busses 722 for communication with processor(s) 700 during initialization steps. JTAG/I2C busses 722 are also coupled to L2 cache 704, Host-to-PCI bridge 706, and main memory 708 providing a communications path between the processor, the Service Processor, the L2 cache, the Host-to-PCI bridge, and the main memory. Service Processor 716 also has access to system power resources for powering down information handling device 701.

Peripheral devices and input/output (I/O) devices can be attached to various interfaces (e.g., parallel interface 762, serial interface 764, keyboard interface 768, and mouse interface 770 coupled to ISA bus 740. Alternatively, many I/O devices can be accommodated by a super I/O controller (not shown) attached to ISA bus 740.

In order to attach computer system 701 to another computer system to copy files over a network, LAN card 730 is coupled to PCI bus 710. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method for dynamically adjusting an agenda using a computer system, said method comprising:
receiving a request, the request corresponding to a first agenda item from a plurality of agenda items included in the agenda;
retrieving one or more first agenda item attributes corresponding to the first agenda item;
determining whether to adjust one or more of the first agenda item attributes based upon the request; and
adjusting one or more of the first agenda item attributes in response to the determination.

2. The method as described in claim 1 wherein at least one of the first agenda item attributes are selected from the group consisting of a start time, an end time, a progress indicator, a timeslot, a time window, and a font property.

3. The method as described in claim 1 further comprising:
identifying one or more first agenda item participants corresponding to the first agenda item; and
notifying one or more of the first agenda item participants in response to the adjusting.

4. The method as described in claim 1 further comprising:
identifying a second agenda item from the plurality of agenda items, wherein the second agenda item is subsequent to the first agenda item;
determining whether to change one or more second agenda item attributes corresponding to the second agenda item in response to the adjusting; and
changing one or more of the second agenda item attributes in response to the determining.

5. The method as described in claim 1 further comprising:
detecting that the request is an agenda item order change request, the agenda item order change request corresponding to a new agenda order;
analyzing the new agenda order, the analyzing including identifying a second agenda item whose timeslot requires changing in response to the new agenda order;
changing the second agenda's timeslot in response to the analyzing; and
notifying one or more participants in response to the changing.

6. The method as described in claim 1 further comprising:
receiving a subscription request from a participant, the subscription request associated with an entry point that corresponds to the first agenda item;
selecting the first agenda item;
notifying the participant in response to the selecting; and
subscribing the participant in response to the notifying.

7. The method as described in claim 1 further comprising:
modifying a progress indicator based upon the request, wherein the modifying corresponds to the progress of the first agenda item.

8. An information handling system comprising:
one or more processors;
a memory accessible by the processors;
one or more nonvolatile storage devices accessible by the processors; and
an agenda management tool for dynamically adjusting an agenda, the agenda adjustment tool comprising software code effective to:
receive a request, the request corresponding to a first agenda item from a plurality of agenda items included in the agenda;
retrieve one or more first agenda item attributes corresponding to the first agenda item;
determine whether to adjust one or more of the first agenda item attributes based upon the request; and
adjust one or more of the first agenda item attributes in response to the determination.

9. The information handling system as described in claim 8 wherein at least one of the first agenda item attributes are selected from the group consisting of a start time, an end time, a progress indicator, a timeslot, a time window, and a font property.

10. The information handling system as described in claim 8 wherein the software code is further effective to:
identify one or more first agenda item participants corresponding to the first agenda item; and
notify one or more of the first agenda item participants in response to the adjusting.

11. The information handling system as described in claim 8 wherein the software code is further effective to:
identify a second agenda item from the plurality of agenda items, wherein the second agenda item is subsequent to the first agenda item;
determine whether to change one or more second agenda item attributes corresponding to the second agenda item in response to the adjusting; and
change one or more of the second agenda item attributes in response to the determining.

12. The information handling system as described in claim 8 wherein the software code is further effective to:
detect that the request is an agenda item order change request, the agenda item order change request corresponding to a new agenda order;
analyze the new agenda order, the analyzing including identifying a second agenda item whose timeslot requires changing in response to the new agenda order;
change the second agenda's timeslot in response to the analyzing; and
notify one or more participants in response to the changing.

13. The information handling system as described in claim 8 wherein the software code is further effective to:
receive a subscription request from a participant, the subscription request associated with an entry point that corresponds to the first agenda item;
select the first agenda item;
notify the participant in response to the selecting; and
subscribe the participant in response to the notifying.

14. A computer program product stored on a computer operable media for dynamically adjusting an agenda, said computer program product comprising:
means for receiving a request, the request corresponding to a first agenda item from a plurality of agenda items included in the agenda;
means for retrieving one or more first agenda item attributes corresponding to the first agenda item;
means for determining whether to adjust one or more of the first agenda item attributes based upon the request; and
means for adjusting one or more of the first agenda item attributes in response to the determination.

15. The computer program product as described in claim 14 wherein at least one of the first agenda item attributes are selected from the group consisting of a start time, an end time, a progress indicator, a timeslot, a time window, and a font property.

16. The computer program product as described in claim 14 further comprising:
means for identifying one or more first agenda item participants corresponding to the first agenda item; and
means for notifying one or more of the first agenda item participants in response to the adjusting.

17. The computer program product as described in claim 14 further comprising:
means for identifying a second agenda item from the plurality of agenda items, wherein the second agenda item is subsequent to the first agenda item;
means for determining whether to change one or more second agenda item attributes corresponding to the second agenda item in response to the adjusting; and
means for changing one or more of the second agenda item attributes in response to the determining.

18. The computer program product as described in claim 14 further comprising:
means for detecting that the request is an agenda item order change request, the agenda item order change request corresponding to a new agenda order;
means for analyzing the new agenda order, the analyzing including identifying a second agenda item whose timeslot requires changing in response to the new agenda order;
means for changing the second agenda's timeslot in response to the analyzing; and
means for notifying one or more participants in response to the changing.

19. The computer program product as described in claim 14 further comprising:
means for receiving a subscription request from a participant, the subscription request associated with an entry point that corresponds to the first agenda item;
means for selecting the first agenda item;
means for notifying the participant in response to the selecting; and
means for subscribing the participant in response to the notifying.

20. The computer program product as described in claim 14 further comprising:
means for modifying a progress indicator based upon the request, wherein the modifying corresponds to the progress of the first agenda item.

21. A method for dynamically adjusting an agenda using a computer system, said method comprising:
receiving a request, the request corresponding to a first agenda item from a plurality of agenda items included in the agenda;
retrieving one or more first agenda item attributes corresponding to the first agenda item, wherein at least one of the first agenda item attributes are selected from the group consisting of a start time, an end time, a progress indicator, a timeslot, a time window, and a font property;
determining whether to adjust one or more of the first agenda item attributes based upon the request;
adjusting one or more of the first agenda item attributes in response to the determination;
identifying one or more first agenda item participants corresponding to the first agenda item; and
notifying one or more of the first agenda item participants in response to the adjusting.

22. A method for dynamically adjusting an agenda using a computer system, said method comprising:
receiving a request, the request corresponding to a first agenda item from a plurality of agenda items included in the agenda;
detecting that the request is an agenda item order change request, the agenda item order change request corresponding to a new agenda order;
retrieving one or more first agenda item attributes corresponding to the first agenda item, wherein at least one of the first agenda item attributes are selected from the group consisting of a start time, an end time, a progress indicator, a timeslot, a time window, and a font property;
determining whether to adjust one or more of the first agenda item attributes based upon the request;
adjusting one or more of the first agenda item attributes in response to the determination;
analyzing the new agenda order, the analyzing including identifying a second agenda item whose timeslot requires changing in response to the new agenda order;
changing the second agenda's timeslot in response to the analyzing; and
notifying one or more participants in response to the changing.

23. An information handling system comprising:
one or more processors;
a memory accessible by the processors;
one or more nonvolatile storage devices accessible by the processors; and
an agenda management tool for dynamically adjusting an agenda, the agenda adjustment tool comprising software code effective to:
receive a request, the request corresponding to a first agenda item from a plurality of agenda items included in the agenda;
retrieve one or more first agenda item attributes corresponding to the first agenda item, wherein at least one of the first agenda item attributes are selected from the group consisting of a start time, an end time, a progress indicator, a timeslot, a time window, and a font property;
determine whether to adjust one or more of the first agenda item attributes based upon the request;
adjust one or more of the first agenda item attributes in response to the determination;
identify one or more first agenda item participants corresponding to the first agenda item; and
notify one or more of the first agenda item participants in response to the adjusting.

24. A computer program product stored on a computer operable media for dynamically adjusting an agenda, said computer program product comprising:
means for receiving a request, the request corresponding to a first agenda item from a plurality of agenda items included in the agenda;
means for retrieving one or more first agenda item attributes corresponding to the first agenda item, wherein at least one of the first agenda item attributes are selected from the group consisting of a start time, an end time, a progress indicator, a timeslot, a time window, and a font property;
means for determining whether to adjust one or more of the first agenda item attributes based upon the request;
means for adjusting one or more of the first agenda item attributes in response to the determination;
means for identifying one or more first agenda item participants corresponding to the first agenda item; and
means for notifying one or more of the first agenda item participants in response to the adjusting.

25. A computer program product stored on a computer operable media for dynamically adjusting an agenda, said computer program product comprising:
means for receiving a request, the request corresponding to a first agenda item from a plurality of agenda items included in the agenda;
means for detecting that the request is an agenda item order change request, the agenda item order change request corresponding to a new agenda order;
means for retrieving one or more first agenda item attributes corresponding to the first agenda item, wherein at least one of the first agenda item attributes are selected from the group consisting of a start time, an end time, a progress indicator, a timeslot, a time window, and a font property;
means for determining whether to adjust one or more of the first agenda item attributes based upon the request;
means for adjusting one or more of the first agenda item attributes in response to the determination;
means for analyzing the new agenda order, the analyzing including identifying a second agenda item whose timeslot requires changing in response to the new agenda order;
means for changing the second agenda's timeslot in response to the analyzing; and
means for notifying one or more participants in response to the changing.
